(19) United States
(12) Patent Application Publication
(10) Pub. No.: US 2005/0227208 A1
(43) Pub. Date: Oct. 13, 2005

(54) Printed publication with 3-D object

(75) Inventors: Santiago Jose Beascoa, Barcelona (ES); Peng Cheong Loo, Easton, CT (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Bunamir, S.L.

(21) Appl. No.: 10/969,229

(22) Filed: Oct. 19, 2004

(30) Foreign Application Priority Data
Apr. 7, 2004 (ES) U200400890

(51) Int. Cl. G09B 27/08; G09B 5/00

(52) U.S. Cl. 434/131

(57) ABSTRACT

In a printed publication such as a book, an inflatable 3-D object is mounted by an attachment device in an opening in the printed publication. The inflatable object relates to the content of the printed publication and is adapted for relative movement to the printed publication. For storage purposes, a container is dimensionally sized to fit in the opening and to contain the inflatable object once deflated.

### BACKGROUND OF THE INVENTION

1. Technical Field

The present invention relates generally to printed publications and the like. More particularly, it relates to a book or other publication having implanted therein a 3-D object such as an inflatable object relating to the content of the book or publication.

2. Description of the Background Art

There are various books on the market that include objects to make it easier to understand and comprehend the book to which they are attached.

Spanish Utility Model No. 131856, in the name of Mr. Jose Luis Gutierrez Diez is known, from 1967, relating to a didactic-educational device for children, which is characterized by the arrangement, that may or not form part of a book, of one or several sheets containing complete graphic illustrations, but without any details or parts, as well as the arrangement of other sheets which, in the same case, have a series of figures-transfers on a transparent surface that can be transferred on to the figure in the aforementioned illustration by covering those spaces that are considered the most suitable according to the subject or representation, whereby the cover sheet can position the figure on the whole first so that its effect can be observed, before rubbing the back so that the figure in question is transferred to the illustration sheet by means of paraffin-covered paper that protects the figures on the support sheet.

Also European Patent No. 0832674, from 1997, is known, and its equivalent U.S. Pat. No. 5,681,199, in the name of READERS DIGEST CHILDREN'S PUBLISHING, INC., which relates to a book in which one or more covers or pages are bound using a binding method that is adapted to receive a tube and a play figure which extends in a removable fashion inside the tube. The play figure has a top part and a hook element. An activity device is also supplied with the book. The activity device is activated so that the play figure is extended within the tube, using the bottom part of the play figure. A musical device could be provided inside the tube to produce a sound for a certain length of time after the activity device has been activated.

### SUMMARY OF THE INVENTION

This utility model is the result of research conducted by the inventors in the field of education and bibliography, in an attempt to combine in one and the same book or publication, and also in a permanently visible fashion, various elements that are essential for understanding the book or publication.

Everybody will admit that when reading a history or geography book or publication, for example, it is very useful to have a globe nearby so as to identify the country or continent in question that is referenced in the text.

It is also known that, on occasions, when reading a book or publication on anatomy, it is necessary to have an anatomy manual or atlas nearby so as to identify each part of the body as per the contents in the volume being read.

The inventors considered the case in which the globe, atlas or manual is not available at that moment, and so the actual book or publication must provide the information, either at the end of the book or publication, or by means of an appendix.

Both solutions are awkward, as they distract from reading, and if we consider this occurring with younger readers, a small distraction can lead to a lack of concentration on reading and the excuse or reason given for stopping to read the book or publication at that moment.

Therefore, the inventors have developed a new printed publication such as a book or other publication that solves the aforementioned problems, as it is the actual book or publication that contains the globe, atlas or graphical element in a way that it is permanently visible, and therefore it is not necessary to stop concentrating on the book or publication, as the information the reader may require is on view at all times.

Furthermore, children can consider this to be an entertaining toy, with the printed publication becoming much more interesting to read, as without realizing it, children are receiving information visually from a rotationally mounted inflatable object in the printed publication.

An object of this invention is a printed publication with an inflatable 3-D object. The printed publication has a front cover, at least one leaf and a back cover arranged in an orderly fashion and joined on one side thereof by a spine. At least one of the front cover, the at least one leaf and the back cover defines an opening. An attachment device is provided for positioning the inflatable object in the opening. The inflatable object relates to the content of the printed publication.

The inflatable element can be removable and therefore, after being used, it can be kept in a box or container suitably sized to fit in the opening in the printed publication, and in this way the printed publication is completely uniform and the box or container does not protrude from it.

The simplicity and adaptability of this invention, as well as its versatility, together with the visual effect it has on the reader, exploit this invention to the full.

The invention will be fully understood when reference is made to the following detailed description taken in conjunction with the accompanying drawings.

### BRIEF DESCRIPTION OF THE DRAWINGS

Drawings are attached to this specification to facilitate the explanation thereof, which illustrate a practical embodiment that is referenced merely as a non-limiting example of the scope of the invention, in which:

FIG. 1 is a perspective view of the printed publication of this invention in an open condition with the inflatable object inflated and installed;

FIG. 2 is a front view of the printed publication of this invention in an open condition with the object removed;

FIG. 3 is a perspective view of the printed publication closed with the box or container housing the inflatable object installed;

FIG. 4 is a perspective view of the printed publication opened with the box or container housing the inflatable object installed;

FIG. 5 is a perspective view of the printed publication opened with the box or container housing the inflatable object being removed;

FIG. 6 is a perspective view of the box or container opened and the inflatable object being removed;

FIG. 7 is a perspective view of the inflatable object;

FIG. 8 is a front view of the printed publication of this invention in an open condition with the inflatable object inflated and installed;

FIG. 9 is a cross-sectional view of the valve of the inflatable object;

FIG. 10 is a front view of a portion of the printed publication and inflatable object with portions broken away and in cross-section to show the valve of the inflatable object being engaged by a lug for removably and rotationally positioning the inflatable object in the opening of the printed publication;

FIG. 11 is a front view of a portion of the printed publication and inflatable object with portions broken away and in cross-section to show the recess of the inflatable object being engaged by a lug for removably and rotationally positioning the inflatable object in the opening of the printed publication;

FIG. 12 is a cross-sectional view taken along the 12-12 line of FIG. 11; and

FIG. 13 is a perspective view of a second embodiment of the printed publication of this invention in an closed condition with two inflatable objects inflated and installed.

### DETAILED DESCRIPTION OF THE INVENTION

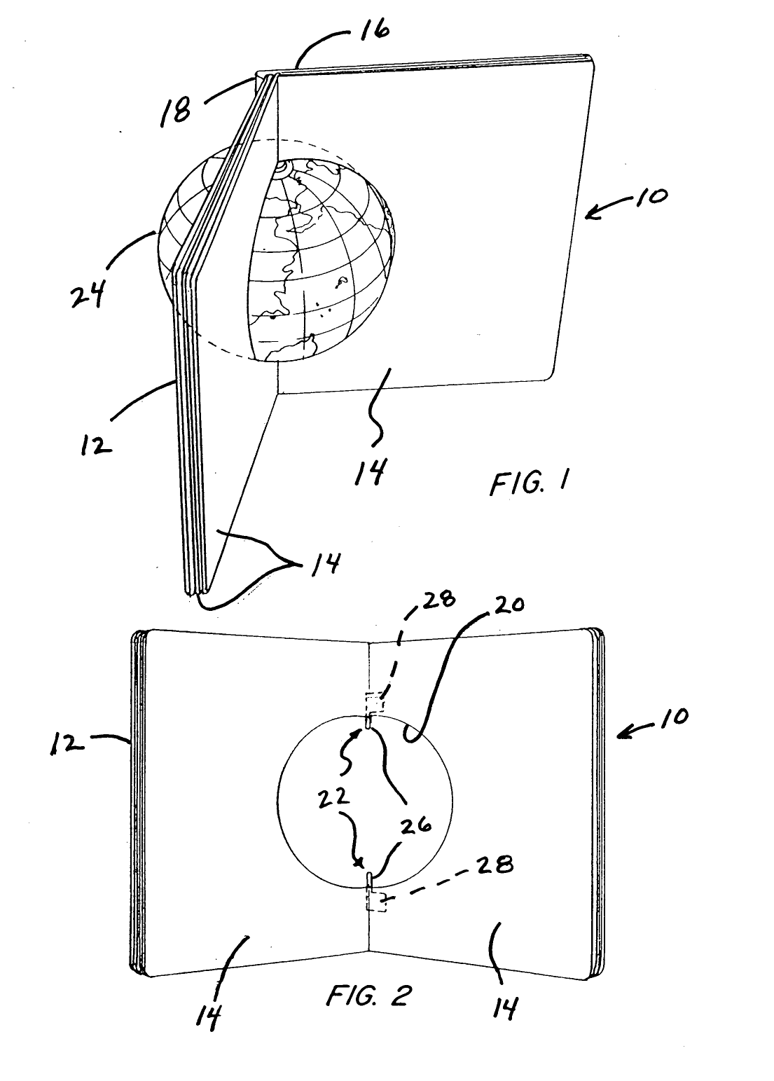

Turning first to FIG. 1, therein is illustrated a book or other printed publication 10 with a front cover 12, one or more leaves 14 and a back cover 16. The printed publication 10 is ideally a board book made from heavy cardboard material. The front cover 12, leaves 14 and back cover 16 are arranged in an orderly fashion, joined on one side thereof by a spine 18 and define an opening or cavity 20 (FIG. 2).

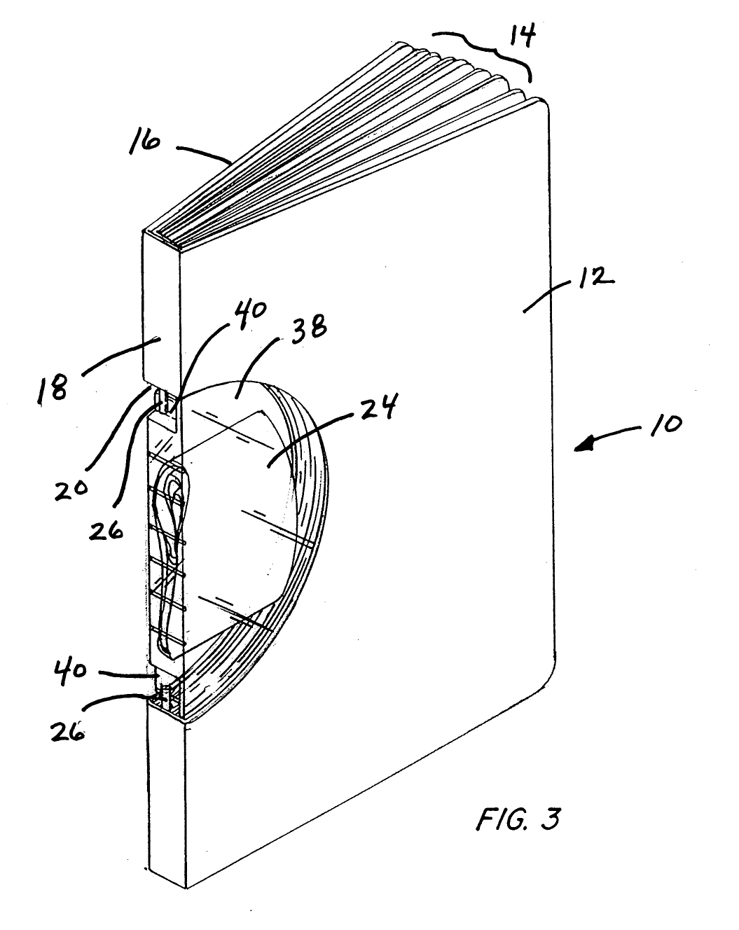

The opening 20 in this particular embodiment has been defined through and along the spine 18 of the printed publication 10 which separates the spine 18 into two portions. The opening 20 is semicircular when the printed publication 10 is closed (see FIG. 3), with the diameter of the semicircle lying on the extension of the spine 18 of the printed publication 10.

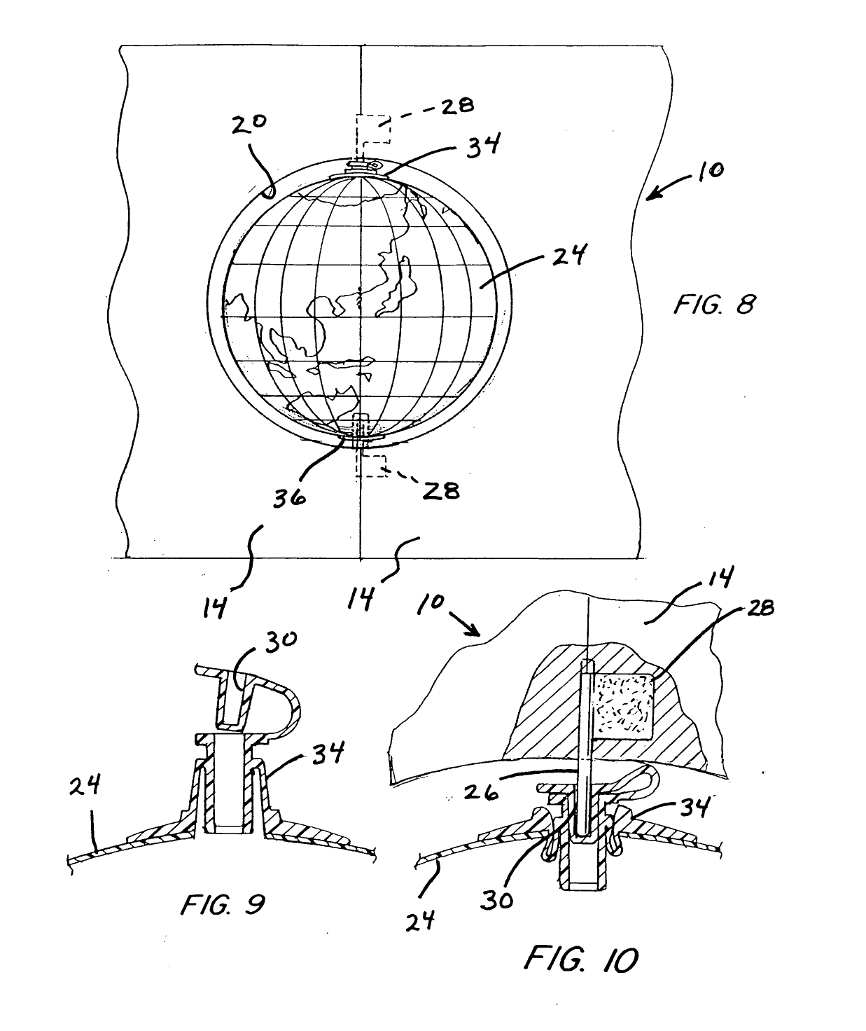

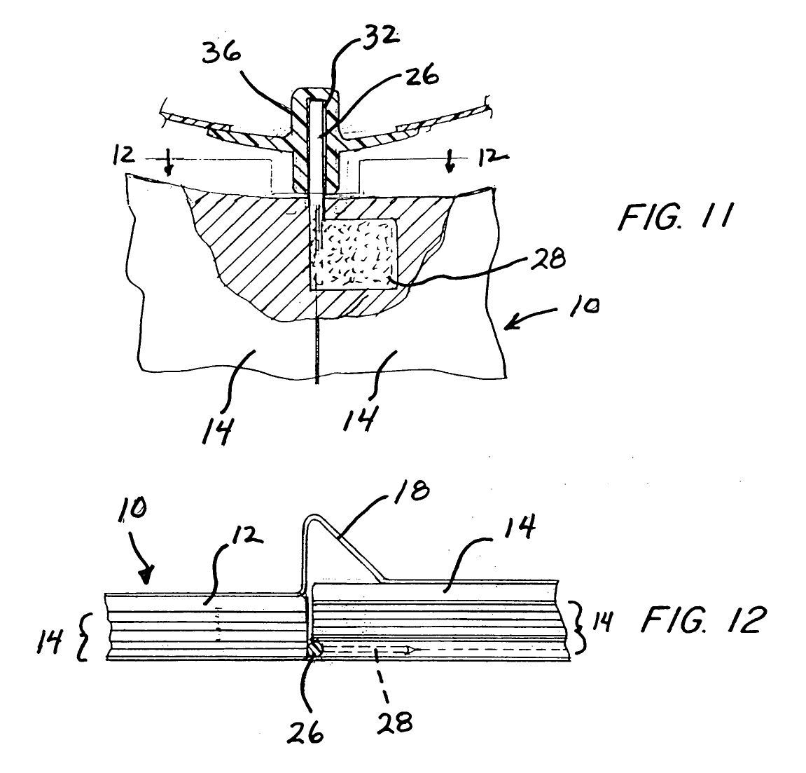

An attachment device generally indicated by the numeral 22 is provide for positioning an inflatable object 24 in the opening 20. The attachment device 22 is a pair of oppositely arranged lugs 26 which have flanges 28 which are captured within one of the front cover 12, leaves 14 and back cover 16 of the printed publication 10. See FIGS. 2 and 8-12.

The inflatable object 24 is positioned in the opening by the attachment device 22 and relates to the content of the printed publication. For example, the inflatable object 24 can be in the form of a globe if the printed publication is a geography book or publication. The inflatable object 24 has recesses 30, 32 (FIGS. 9-11) therein which are engaged by the pair of oppositely arranged lugs 26 for removably and rotationally positioning the inflatable object 24 in the opening 20. The recess 30 is defined in a molded plastic valve 34 of the inflatable object 24 while the other recess 32 is defined in a molded plastic surface portion 36 of inflatable object 24 diametrically opposite the valve 34. The valve 34 is used to inflate and deflate the inflatable object 24 in the same manner as an inflatable beach ball. The inflatable object 24 is made from a plastic vinyl type material which can be printed upon.

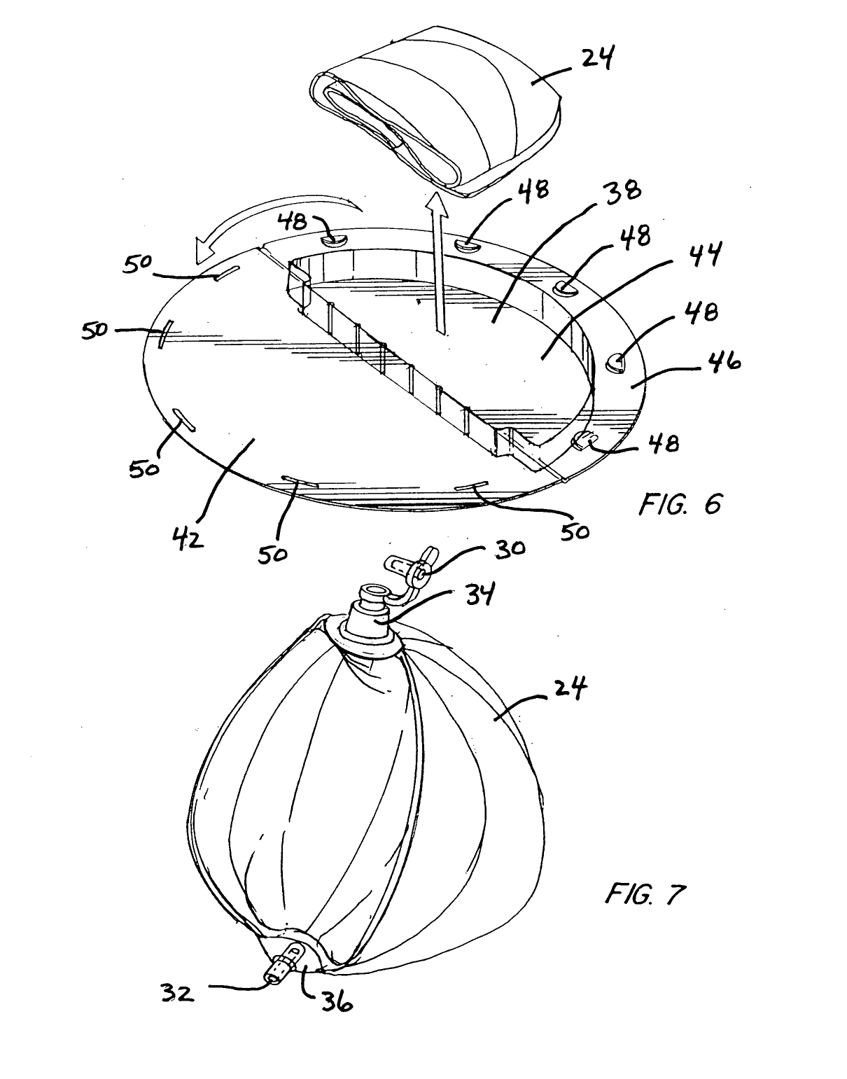

To contain and store the inflatable object 24 when not in use, a container 38 (FIGS. 3-6) is provide preferably formed from a thin, clear plastic sheet material. The container 38 is dimensionally sized to accommodate the inflatable object 24 when deflated. To fit in the opening 20, the container 38 includes indented portions 40 to avoid interference with the lugs 26. As best seen in FIG. 6, the container 38 has a lid 42 and a container shell 44 which has a flange 46 thereon. The flange 46 and the lid 42 are provided with mating cutouts 48 and oval openings 50 which interlock to hold the lid 42 in a closed position on the container 38. The flange 46 and lid 42 are designed to extend between at least two of the front cover 12, leaves 14 and back cover 16 to retain the container 44 therebetween when the printed publication 10 is in a closed position.

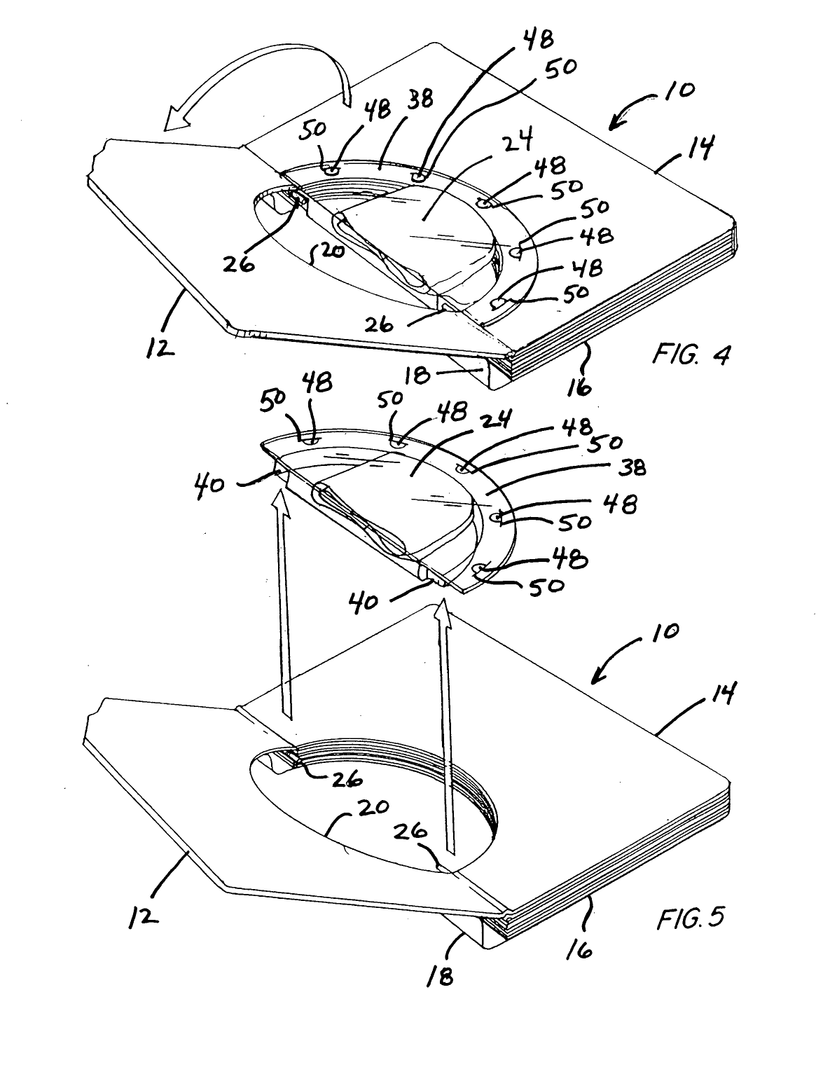

When the printed publication 10 is first purchased, it comes in its closed position as shown in FIG. 3 with the container 44 having the deflated inflatable object 24 therewithin. As shown In FIG. 4, the flange 46 and lid 42 of the container 44 extend between at least two of the front cover 12, leaves 14 and back cover 16 retaining the container 44 therebetween and in the opening 20.

To utilize the inflatable object 24, the user would open the printed publication 10 (FIG. 4), remove the container 44 from the printed publication 10 (FIG. 5) and remove the deflated inflatable object 24 from the container 44 (FIG. 6). The user would unfold the inflatable object 24 as shown in FIG. 7, then blow air into the valve 34 to inflate the inflatable object 24 and rotatably mount the inflatable object 24 in the opening between the two lugs 26 using the recesses 30, 32 (FIGS. 1, 8 and 10-11). The user can then open the printed publication 10 and view the various pages on the leaves 14 which have certain content relating to the inflatable object 24. For example, supposing that the printed publication 10 is a geography book or publication, if the user does not know the location of a certain country or continent, the user only needs to look on the rotatable inflatable object 24, which would be a globe, and which is always visible from any page, so that the user can continue concentrating on reading the printed publication 10.

Once the user has finished reading the printed publication 10, the user only has to release the inflatable object 24 from the lugs 26, deflate the inflatable object 24 using the valve 34 and return it to container 38 so that subsequently the container 38 can be repositioned inside the printed publication 10.

In this embodiment example, the inflatable object 24 is removable, although it can be designed to be non-removable and without the container 38 according to requirements. In this particular embodiment, the opening 20 is in the center of the printed publication 10, although it could be in any other part of the book or publication and perform its function perfectly.

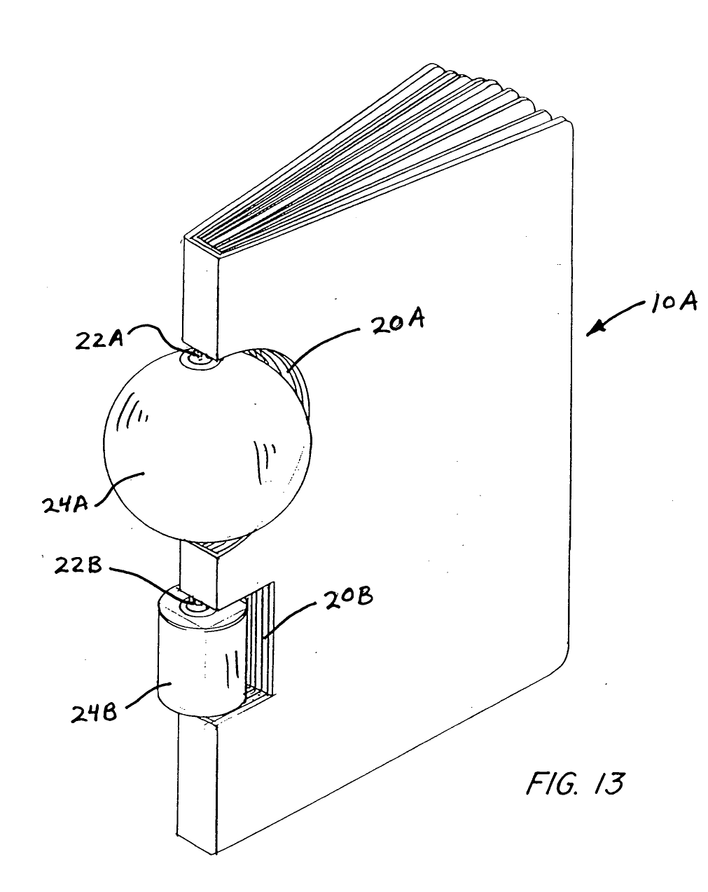

As shown in FIG. 13, the essence of this invention would not be altered if the printed publication 10A were to have two or more openings 20A, 20B with respective attachment means 22A, 22B and inflatable objects 24A, 24B, since including more than one inflatable object in every book or publication only depends on the size of the book or publication and the inflatable object.

This invention describes a new and novel book or publication with a 3-D inflatable object. It is believed that the many advantages of this invention will now be apparent to those skilled in the art. It will also be apparent that a number of variations and modifications may be made therein without departing from its spirit and scope. Accordingly, the foregoing description is to be construed as illustrative only, rather than limiting. This invention is limited only by the scope of the following claims.

1. A combination comprising:
(a) a printed publication having a certain content, the printed publication having a front cover, at least one leaf and a back cover arranged in an orderly fashion and joined on one side thereof by a spine, at least one of the front cover, the at least one leaf and the back cover defining an opening;
(b) an attachment device for positioning at least one inflatable object in the opening; and
(c) at least one inflatable object positioned in the opening by the attachment device, the inflatable object relates to the content of the printed publication.

2. The combination according to claim 1, wherein the inflatable object is removably attached in the opening by the attachment device.

3. The combination according to claim 1, wherein the attachment device is a pair of oppositely arranged lugs.

4. The combination according to claim 3, wherein the at least one inflatable object has recesses therein which are engaged by the pair of oppositely arranged lugs for positioning the at least one inflatable object in the opening.

5. The combination according to claim 4, wherein at least one of the recesses are defined in a valve of the at least one inflatable object, the valve being useable to inflate and deflate the at least one inflatable object.

6. The combination according to claim 1, wherein the at least one inflatable object has recesses therein which are engaged by the attachment device for positioning the at least one inflatable object in the opening.

7. The combination according to claim 6, wherein at least one of the recesses is defined in a valve of the at least one inflatable object, the valve being useable to inflate and deflate the at least one inflatable object.

8. The combination according to claim 1, wherein the inflatable object is rotationally mounted by the attachment device.

9. The combination according to claim 1, wherein the inflatable object is mounted by the attachment device for movement relative to the printed publication.

10. The combination according to claim 1, wherein the opening is defined along the spine and separates the spine into two portions.

11. The combination according to claim 1, wherein the opening is semicircular when the publication is a closed position, a diameter of the semicircle lying on an extension of the spine.

12. The combination according to claim 1, wherein the front cover, the at least one leaf and the back cover all define the opening.

13. The combination according to claim 1, wherein at least one of the front cover, the at least one leaf and the back cover defining a second opening with a second inflatable object positioned therein by a second attachment device.

14. The combination according to claim 1, further comprising a container dimensionally sized to fit in the opening and to contain the inflatable object once deflated.

15. The combination according to claim 1, wherein the container has a lid and flange thereon which extends between at least two of the front cover, the at least one leaf and the back cover to retain the container therebetween when the printed publication is in a closed position.

16. A kit comprising:
(a) a printed publication having a front cover, at least one leaf and a back cover arranged in an orderly fashion and joined on one side thereof by a spine, at least one of the front cover, the at least one leaf and the back cover defining an opening;
(b) an attachment device for positioning at least one inflatable object in the opening; and
(c) at least one inflatable object positionable in the opening by the attachment device, the inflatable object relates to the content of the printed publication.

17. The kit according to claim 16, wherein the inflatable object is removably attachable in the opening by the attachment device.

18. The kit according to claim 16, wherein the attachment device is a pair of oppositely arranged lugs.

19. The kit according to claim 16, wherein the at least one inflatable object has recesses therein which are dimensionally sized to engage the pair of oppositely arranged lugs for positioning the at least one inflatable object in the opening.

20. The kit according to claim 19, wherein at least one of the recesses is defined in a valve of the at least one inflatable object, the valve being useable to inflate and deflate the at least one inflatable object.

21. The kit according to claim 16, wherein the at least one inflatable object has recesses therein which are dimensionally sized to engage the attachment device for positioning the at least one inflatable object in the opening.

22. The kit according to claim 21, wherein at least one of the recesses is defined in a valve of the at least one inflatable object, the valve being used to inflate the at least one inflatable object.

23. The kit according to claim 16, wherein the inflatable object is adapted to be rotationally mounted by the attachment device.

24. The kit according to claim 16, wherein the inflatable object is adapted to be mounted by the attachment device for movement relative to the printed publication.

25. The kit according to claim 16, wherein the opening is defined along the spine and separates the spine into two portions.

26. The kit according to claim 16, wherein the opening is semicircular when the publication is a closed position, a diameter of the semicircle lying on an extension of the spine.

27. The kit according to claim 16, wherein the front cover, the at least one leaf and the back cover all define the opening.

28. The kit according to claim 16, wherein at least one of the front cover, the at least one leaf and the back cover defining a second opening and further comprising a second inflatable object dimensionally sized to be positioned in the second opening by a second attachment device.

29. The kit according to claim 16, further comprising a container dimensionally sized to fit in the opening and to contain the inflatable object once deflated.

30. The kit according to claim 16, wherein the container has a flange and lid thereon which can be positioned to extend between at least two of the front cover, the at least one leaf and the back cover to retain the container therebetween when the printed publication is in a closed position.
